(19) United States
(12) Patent Application Publication
(10) Pub. No.: US 2024/0107475 A1
(43) Pub. Date: Mar. 28, 2024

(54) RADIO COMMUNICATIONS

(71) Applicant: Nordic Semiconductor ASA, Trondheim (NO)

(72) Inventor: Karthik KHANNA, Hyderabad (IN)

(73) Assignee: Nordic Semiconductor ASA, Trondheim (NO)

(21) Appl. No.: 18/367,965

(22) Filed: Sep. 13, 2023

(30) Foreign Application Priority Data
Sep. 15, 2022 (IN) 202211052826
Nov. 10, 2022 (GB) 2216765.4

(51) Int. Cl. H04W 56/00

(52) U.S. Cl. CPC H04W 56/0035; H04W 84/12

(57) ABSTRACT

A radio receiver device is disclosed. The radio receiver device is configured to receive a radio signal comprising a data packet, said data packet comprising a first portion comprising an encoded bit sequence and including information specific to the data packet and a second portion comprising an encoded bit sequence and comprising corresponding information specific to the data packet. The radio receiver device is configured to calculate a correlation metric using the first portion and the second portion; and to estimate a carrier frequency offset between the radio signal and the radio receiver device using the correlation metric.

### CROSS REFERENCE TO RELATED APPLICATIONS

This application claims priority from Great Britain Application No. 2216765.4, filed on Nov. 10, 2022, which claims priority from India Application No. 202211052826, filed on Sep. 15, 2022. Both applications are incorporated herein in their entirety.

### BACKGROUND OF THE INVENTION

The present invention relates to radio receiver devices and radio communication systems.

Radio communication involving the transmission and reception of modulated radio-frequency waves is commonplace. Many modern radio communications are, at the physical layer, based on transmitting data between devices in distinct blocks or packets (sometimes referred to as frames).

Typically, a transmitter transmits a data packet by modulating a radio signal with a carrier frequency. For the payload of the data packet to be successfully received by the intended receiver, the receiver must know the timing and carrier frequency of the transmitted data packet. In other words, the receiver must be synchronised with the incoming packet. Frequency synchronisation typically involves estimating and correcting for a carrier frequency offset (CFO), which is the offset between the carrier frequency of the incoming radio signal and a locally-generated oscillating signal used to demodulate and decode the incoming signal.

Each packet typically contains one or more preamble portions and a payload. The preamble portions are used for synchronising the receiver with the incoming packet and the payload is the actual data to be transmitted. The preambles of packets in wireless communications often include fields designed to facilitate CFO estimation, to enable them to properly demodulate and decode the rest of the packet. These fields typically contain known, fixed patterns that a receiver can detect and use to estimate the CFO.

The IEEE 802.11 wireless LAN (“Wi-Fi”) standards define various protocols for wireless network communication. The IEEE 802.11 standards specify, amongst other things, physical layer packet structures (referred to as physical layer protocol data units or PPDUs).

The IEEE 802.11 standard has evolved over more than 20 years. The 802.11 standards are designed to be backward compatible (i.e. so that a client device station designed for an earlier version of the standard can continue to operate with newer versions of the standard). Thus, a packet structure specified by a later version of the 802.11 standard normally includes preamble fields from previous versions. These are often referred to as “legacy” fields.

The 802.11ax protocol (also referred to as Wi-Fi 6), introduces many improvements over previous versions. One notable advancement in 802.11ax is the use of an orthogonal frequency-division multiple access (OFDMA) modulation scheme, in which a data stream is spread over some or all of a radio channel containing multiple subcarriers. The use of OFDMA can improve network capacity and throughput. OFDMA requires accurate timing and carrier synchronisation. The 802.11ax preamble includes a legacy Short Training Field (L-STF) and a legacy Long Training Field (L-LTF) which contain fixed repeating patterns that can be used for CFO estimation.

Improved approaches to receiver synchronisation may be desired.

### SUMMARY OF THE INVENTION

According to a first aspect of the present invention there is provided a radio receiver device configured:
to receive a radio signal comprising a data packet, said data packet comprising a first portion comprising an encoded bit sequence and including information specific to the data packet and a second portion comprising an encoded bit sequence and comprising corresponding information specific to the data packet;
to calculate a correlation metric using the first portion and the second portion; and
to estimate a carrier frequency offset between the radio signal and the radio receiver device using the correlation metric.

According to a second aspect of the present invention there is provided a method of operating a radio receiver device, said method comprising:
receiving a radio signal comprising a data packet, said data packet comprising a first portion comprising an encoded bit sequence and including information specific to the data packet and a second portion comprising an encoded bit sequence and comprising corresponding information specific to the data packet;
calculating a correlation metric using the first portion and the second portion;
estimating a carrier frequency offset between the radio signal and the radio receiver device using the correlation metric.

According to a third aspect of the present invention there is provided a wireless communication system comprising:
a radio transmitter device arranged to transmit a radio signal comprising a data packet, said data packet comprising a first portion comprising an encoded bit sequence and including information specific to the data packet and a second portion comprising an encoded bit sequence and comprising corresponding information specific to the data packet; and
a radio receiver device as disclosed herein arranged to receive the radio signal.

Thus, it will be appreciated by those skilled in the art that estimating a carrier frequency offset (CFO) using corresponding portions of a data packet that carry packet-specific information may be particularly statistically robust. Because the content of the first portion (and the second portion) is specific to the data packet, it may vary from packet to packet. Using a variable pattern for CFO estimation mitigates systematic errors and artefacts that may arise from the use of fixed patterns and improves the overall accuracy of CFO estimation as the radio receiver device is operated.

The information specific to the data packet may comprise information identifying one or more parameters of or relating to the data packet. For instance, in some sets of embodiments, the information specific to the data packet comprises information identifying a data rate of one or more portions of the data packet. Additionally or alternatively, the information specific to the data packet may identify a length of one or more portions of the data packet (e.g. a total length of the data packet). Because the data rate and/or the length of each received packet may vary, this introduces variation into the patterns used for estimating the CFO, improving robustness.

The first and second portions may comprise the same information (albeit potentially in a different format). In some embodiments, the information comprised by the first and/or second portions may be combined with other information (e.g. carried in other portions) to identify one or more parameters relating to the data packet.

The data packet may be spread over a plurality of frequency bands. In some embodiments, at least part of the data packet is modulated according to an orthogonal frequency-division multiplexing (OFDM) scheme (e.g. an orthogonal frequency-division multiple access (OFDMA) scheme), in which the data packet is spread over multiple orthogonal sub-carrier frequencies (sub-carriers). Establishing an accurate estimate for the carrier frequency offset may be particularly useful for OFDM packets, where accurate timing and frequency synchronisation is very important. The radio signal may comprise a plurality of sub-carriers. The first portion and the second portion may extend over all of the sub-carriers or a subset of the sub-carriers.

In embodiments where data is spread over a plurality of frequency bands (e.g. orthogonal sub-carriers), the radio receiver device may be arranged to perform one or more channel equalisation processes which compensate for differences in channel effects (e.g. fading) between the frequency bands.

The first and second portions comprise encoded bit sequences. For instance, the first and/or second portions may comprise OFDM symbols, in which their respective bit sequences are spread over multiple frequency subcarriers and/or multiple time slots (e.g. with each bit of an OFDM symbol carried simultaneously in a different sub-carrier). The first and second portions may use a phase-shift keying modulation scheme such as binary-phase-shift-keying (BPSK) or Quadrature BPSK (QBPSK). In a set of embodiments, the first and second portions carry the same underlying bit sequence (i.e. the same underlying information). However, as explained in more detail below, this bit sequence may be encoded and/or modulated in different ways in the first and second portions.

In some sets of embodiments, the data packet adheres to an IEEE 802.11 protocol. For instance, the data packet may be an IEEE 802.11ax data packet (e.g. an IEEE 802.11ax High Efficiency Extended Range Single User (HEERSU) format packet, an IEEE 802.11ax High Efficiency Single User (HESU) format packet, an IEEE 802.11ax High Efficiency Multiple User (HEMU) format packet or an IEEE 802.11ax High Efficiency Trigger-Based (HETB) format packet). In such embodiments, the first portion may comprise a legacy signal (L-SIG) field. The second portion may comprise a repeated legacy signal field (RL-SIG).

In embodiments where the data packet is an IEEE 802.11ax HEERSU data packet, the first portion may comprise part of a High Efficiency Signal A (HE SIG-A) field (e.g. a first OFDM symbol in the HE SIG-A field, referred to herein as an HE SIG-A1 field, or a third OFDM symbol in the HE SIG-A field, referred to herein as an HE SIG-A3 field). The second portion may comprise another part of a HE SIG-A field (e.g. a second OFDM symbol in the HE SIG-A field, referred to herein as an HE SIG-A2 field, or a fourth OFDM symbol in the HE SIG-A field, referred to herein as an HE SIG-A4 field).

In a set of embodiments, the second portion comprises a repetition of the first portion. The second portion may be an exact repetition of whole or part of the first portion. It will be recognised that the second portion may still be considered a repetition of the first portion if there are negligible or minor differences (e.g. due to transmission or demodulation errors). In such embodiments, the first and second portions may carry the same underlying bit sequence and use the same encoding and modulation schemes.

Alternatively, the second portion may not be a repetition of the first portion. For instance, the second portion may comprise a transformed version of the first portion (e.g. an interleaved or deinterleaved version of the first portion). Of course, the second portion may still convey the same packet-specific information as the first portion (e.g. the same underlying bit sequence) even if the first and second portions are not direct repetitions.

In a set of embodiments, the first and second portions comprise information spread over a plurality of frequency bands (e.g. orthogonal subcarriers), i.e. with the information multiplexed into different frequency bands. In some such embodiments, the first and second portions spread information differently over the plurality of frequency bands. For instance, the second portion may comprise a frequency-interleaved version of the first portion according to a predetermined interleave function. Conversely, the first portion may comprise a frequency-interleaved version of the second portion.

Additionally or alternatively, in a set of embodiments, the second portion uses a different modulation scheme to the first portion. For instance the first portion may be modulated using BPSK, and the second portion may be modulated using QBPSK.

In a set of embodiments, the estimated carrier frequency offset is used to decode one or more further portions of the data packet (e.g. a payload). The radio receiver device may be arranged to compensate for the carrier frequency offset between the radio signal and the radio receiver device. In a set of embodiments, the radio receiver device comprises a local oscillator (e.g. a voltage-controlled oscillator). The local oscillator may be used for demodulation and/or decoding of the data packet. In some embodiments, the radio receiver device is arranged to adjust the local oscillator to compensate for the estimated carrier frequency offset. In some embodiments, the radio receiver device is arranged to phase-rotate an incoming radio signal (e.g. an incoming baseband signal) to compensate for the estimated carrier frequency offset.

Calculating the correlation metric may comprise performing a correlation operation such as a cross correlation. The cross correlation may be calculated in the frequency domain, or in the time domain. In embodiments using HE SIG-A fields, the cross correlation is calculated in the frequency domain. The radio receiver device may be arranged to derive a phase offset (e.g. between the first and second portions) using the correlation metric (e.g. using said cross correlation). The radio receiver device may be arranged to estimate the CFO using said phase offset.

In embodiments where the second portion comprises a repetition of the first portion, the correlation operation may simply be performed between the first portion (or a part of the first portion) and the second portion (or a part of the second portion), e.g. involving calculating a cross correlation of the first and second portions or parts of the first and second portions. In embodiments where the second portion is not a repetition of the first portion, calculating the correlation metric may comprise performing one or more initial processing steps to one or both of the first and second portions prior to a correlation operation.

For instance, in a set of embodiments, the first and second portions spread information differently over a plurality of frequency bands (e.g. subcarriers), and calculating the correlation metric comprises reordering frequency bands of the first and/or second portions. For example, in embodiments where the second portion comprises a frequency-interleaved version of the first portion (or vice-versa), calculating the correlation metric may comprise de-interleaving (e.g. by inverting a predetermined interleave function) the second portion or interleaving the first portion prior to a correlation operation. In embodiments involving reordering of frequency bands it may be advantageous to perform one or more channel equalisation processes (i.e. to compensate for different channel effects in the different frequency bands) prior to reordering.

In some embodiments where the first and second portions uses a different modulation scheme to the first portion, calculating the correlation metric comprises converting the modulation of the first and/or second portion. For instance, in embodiments where the first portion is BPSK modulated and the second portion is QBPSK modulated, calculating the correlation metric may comprise de-rotating the second portion (or rotating the first portion) prior to a correlation operation.

The carrier frequency offset for the data packet may be estimated using only the first and second portions. However, in some embodiments the data packet may comprise additional portions suitable and used for CFO estimation.

For instance, the data packet may comprise a synchronisation portion which includes a fixed, repeated pattern (i.e. a pattern that is not packet-specific). The data packet may comprise a plurality of synchronisation portions with fixed repeated patterns. The radio receiver device may be configured to estimate the carrier frequency offset between the radio signal and the radio receiver device using a synchronisation portion. In some embodiments, the radio receiver device is configured to determine an initial estimate of the carrier frequency offset between the radio signal and the radio receiver device using a synchronisation portion of the preamble (i.e. before the CFO is estimated using the first and second portions). An additional correlation metric may be calculated for a repeated fixed pattern in a synchronisation portion (e.g. between two repetitions of the fixed pattern). The radio receiver device may be configured to estimate the CFO using said additional correlation metric. Using an additional portion of the preamble for CFO estimation may lead to improved accuracy.

In embodiments where the data packet is an IEEE 802.11ax data packet, the packet may include synchronisation portions such as a legacy Short Training Field (L-STF) or a legacy Long Training Field (L-LTF). One or both of the L-STF or the L-LTF may be used for CFO estimation. The L-STF may include a short (e.g. 0.8 μs) fixed pattern that is repeated up to ten times. The L-STF may be used for packet detection, AGC, timing and/or frequency synchronisation (e.g. CFO estimation) and/or channel estimation. The L-LTF may include a longer (e.g. 3.2 μs) fixed pattern that is repeated twice. The L-LTF may be used for timing and/or frequency synchronisation and/or channel estimation.

One or more synchronisation portions may occur in the packet before the first and second portions. Additionally or alternatively, one or more synchronisation portions may occur after the first and second portions. The radio receiver device may be arranged to determine an initial estimate for the CFO using a synchronisation portion, and then refine this estimate using the first and second portions (i.e. with the carrier frequency offset estimated using the first portion and the second portion comprising a refinement of the initial estimate). Additionally or alternatively, the radio receiver device may be arranged to determine an estimate for the CFO using the first and second portions, and to refine this estimate using the synchronisation portion.

In a set of embodiments, the radio receiver device is arranged to compensate for an initial estimate of the carrier frequency offset calculated using the synchronisation portion (e.g. by adjusting a local oscillator or by phase-rotating a baseband signal), and then to compensate for the carrier frequency offset estimated using the first and second portions (e.g. by further adjustment of the local oscillator or by phase-rotating an incoming signal). In other words, the carrier frequency offset estimated using the first and second portions may comprise a residual CFO offset, after an initial compensation has been made. In other embodiments, the radio receiver device may be arranged to compensate first for the carrier frequency offset estimated using the first and second portions and then to compensate for an estimate of the carrier frequency offset calculated using the synchronisation portion.

In a set of embodiments, the radio receiver portion may be arranged to calculate the correlation metric between the first and second portion using parts of the first and second portion having a length equal to a fixed repeated pattern in a synchronisation portion. For instance, a synchronisation portion (e.g. an L-LTF) may include a repeated 3.2 μs pattern, and 3.2 μs parts of the first and second portion (e.g. an L-SIG and an RL-SIG) may be used to calculate the correlation metric between the first and second portion. This may allow the re-use of correlation hardware and/or software and/or firmware for the synchronisation portion and the first and second portions.

Additionally or alternatively, in a set of embodiments the data packet comprises a third portion including information specific to the data packet. In other words, the data packet may comprise one or more additional portions suitable for CFO estimation which also carry packet-specific information. The information comprised by the third portion may correspond to that comprised by the first and/or second portions, such that the third portion may be used with the first and/or second portion for determining a CFO estimate in a corresponding manner to that described above for the first and second portions. Alternatively, the third portion may include different information.

The data packet may comprise a fourth portion comprising corresponding information to the third portion. In such embodiments, the third and fourth portions may be used to estimate the CFO in a similar manner to that described above with reference to the first and second portions (although the third and fourth portions may of course have different characteristics and be used in different ways to the first and second portions). The third and fourth portions may be used to improve the estimate of CFO between the radio signal and the radio receiver device.

In a set of embodiments, the first portion comprises a legacy signal (L-SIG) field, the second portion comprises a repeated legacy signal field (RL-SIG), the third portion comprises a first part of a HE SIG-A field (e.g. a HE SIG-A1 or HE SIG-A3 field) and the fourth portion comprises a second part of a HE SIG-A field (e.g. a HE SIG-A2 or HE SIG-A4 field). In another set of embodiments, the first portion comprises a first part of a HE SIG-A field (e.g. a HE SIG-A1 field), the second portion comprises a second part of a HE SIG-A field (e.g. a HE SIG-A2 field), the third portion comprises a third part of a HE SIG-A field (e.g. a HE SIG-A3 field) and the fourth portion comprises a fourth part of a HE SIG-A field (e.g. a HE SIG-A4 field).

The data packet may comprise further portions, e.g. fifth and sixth portions which can provide further input to a CFO estimate in an analogous manner to the methods described above. For instance, In a set of embodiments, the first portion comprises a legacy signal (L-SIG) field, the second portion comprises a repeated legacy signal field (RL-SIG), the third portion comprises a first part of a HE SIG-A field (e.g. a HE SIG-A1 field), the fourth portion comprises a second part of a HE SIG-A field (e.g. a HE SIG-A2 field), the fifth portion comprises a third part of a HE SIG-A field (e.g. a HE SIG-A3 field) and the sixth portion comprises a fourth part of a HE SIG-A field (e.g. a HE SIG-A4 field).

In embodiments where the data packet comprises multiple pairs of portions suitable for determining CFO estimates (e.g. first and second portions, and third and fourth portions), the radio receiver device may be arranged to estimate the CFO by combining (e.g. averaging) intermediate CFO estimates determined separately from each pair. For instance the radio receiver device may be arranged to determine a first intermediate CFO estimate using said first and second portions, to determine a second intermediate CFO estimate using said third and fourth portions, and to estimate the carrier frequency offset between the radio signal and the radio receiver device using the first and second intermediate CFO estimates (e.g. by calculating an average such as a mean).

Alternatively, the radio receiver device may be arranged to combine correlation metrics calculated from each pair of portions and use the result to estimate the CFO. For instance, the radio receiver device may be arranged to calculate a first correlation metric using the first portion and the second portion, to calculate a second correlation metric using a third portion and a fourth portion, to calculate a combined correlation metric from said first and second correlation metrics (e.g. by addition) and to estimate the carrier frequency offset between the radio signal and the radio receiver device using the combined correlation metric.

The radio receiver device may use the first and second portions (and/or further portions, in relevant embodiments) of the data packet for one or more other processes. For instance, the radio receiver device may determine the one or more parameters specific to the data packet identified by the first portion (or the second portion). The radio receiver device may use the determined parameters when decoding or otherwise processing one or more other portions of the data packet.

The radio receiver device may be configured to categorise a type of data packet received in response to detecting the first and second portions (e.g. in response to detecting that the second portion is a repetition of the first portion). For instance, in some types of packet the first portion may not be repeated, and in other types the first portion may be repeated (as the second portion). The radio receiver device may be arranged to use a correlation metric to detect the presence of the first and second portions (e.g. to detect a repetition of the first portion). This may be the same as the correlation metric used to estimate the CFO, or it may be different. Using the same correlation metric may advantageously allow some of the same hardware and/or software and/or firmware to be re-used for CFO estimation and packet type detection.

In embodiments where the data packet is an IEEE 802.11ax data packet and the second portion comprises a repetition of the first portion, the radio receiver device may be configured to categorise the data packet as an IEEE 802.11ax packet in response to detecting the presence of the first and second portions (e.g. in response to detecting the RL-SIG as a repetition of the L-SIG).

In embodiments where the data packet is an IEEE 802.11ax HEERSU data packet, the radio receiver device may be configured to determine information for decoding the data packet from the first and/or second portions (e.g. a modulation coding scheme (MCS) or a physical layer protocol data unit (PPDU) bandwidth). For instance, the HE SIG-A fields may carry MCS or PPDU bandwidth information.

The carrier frequency offset for a given packet may be estimated using only that packet. For instance, the radio receiver device may make an entirely new estimate of the CFO for every new packet that arrives (e.g. based only on measurements of that packet). However, in some sets of embodiments the radio receiver device is arranged to estimate the carrier frequency offset between the radio signal and the radio receiver device using a previously-estimated or otherwise previously-known carrier frequency offset. For instance, the radio receiver device may be arranged to calculate a weighted sum of a previously-estimated or otherwise previously-known carrier frequency offset and the carrier frequency offset estimated using the correlation metric. These may be weighted evenly (i.e. to calculate a mean CFO), or they may be weighted unevenly. The radio receiver device may be arranged to compensate for a previously-estimated or otherwise previously-known CFO and then perform further compensation based on the CFO estimated from the correlation metric between the first and second portions.

The radio receiver device may be arranged to retrieve a previously-estimated or otherwise previously-known carrier frequency offset from a memory (e.g. a memory of the radio receiver device or an external memory). The radio receiver device may be arranged to store the carrier frequency offset estimated using the correlation metric to a memory (e.g. a memory of the radio receiver device or an external memory).

The radio receiver device may comprise a radio frequency frontend portion. The radio frequency frontend portion may be arranged to receive and sample the radio signal. The radio frequency frontend portion may comprise one or more DACs, ADCs, mixers, filters, amplifiers and/or baluns. The radio receiver device may comprise a processor (e.g. a baseband processor) arranged to calculate the correlation metric using the first portion and the second portion and/or to estimate the CFO between the radio signal and the radio receiver device using the correlation metric. This or another processor of the radio receiver device may perform other steps of embodiments disclosed herein.

The radio receiver device may comprise a radio transceiver device (i.e. able to transmit and receive data packets). The radio receiver device may comprise an IEEE 802.11 station such as an IEEE 802.11 access point or an IEEE 802.11 client device station. The radio signal may be transmitted be a radio transmitter device (e.g. a radio transceiver device). The radio transmitter device may comprise an IEEE 802.11 station such as an IEEE 802.11 access point or an IEEE 802.11 client device.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a block diagram of wireless communication system according to an example of the present invention;

FIG. 2 shows an exemplary 802.11ax High Efficiency Extended Range Single User (HEERSU) packet structure;

FIG. 3 is a schematic diagram illustrating a method of carrier frequency offset estimation in the time domain;

FIG. 4 is a schematic diagram illustrating a method of carrier frequency offset estimation in the frequency domain;

FIG. 5 is a schematic diagram illustrating a method of carrier frequency offset estimation using HE SIG-A fields of an 802.11ax HEERSU packet;

FIG. 6 is a schematic diagram illustrating a method of carrier frequency offset estimation in the frequency domain;

FIG. 7 is a schematic diagram illustrating a method of carrier frequency offset estimation comprising blending with previously-estimated or otherwise previously known CFO estimates; and

FIG. 8 shows another 802.11ax packet structure for use in embodiments of the invention.

### DETAILED DESCRIPTION

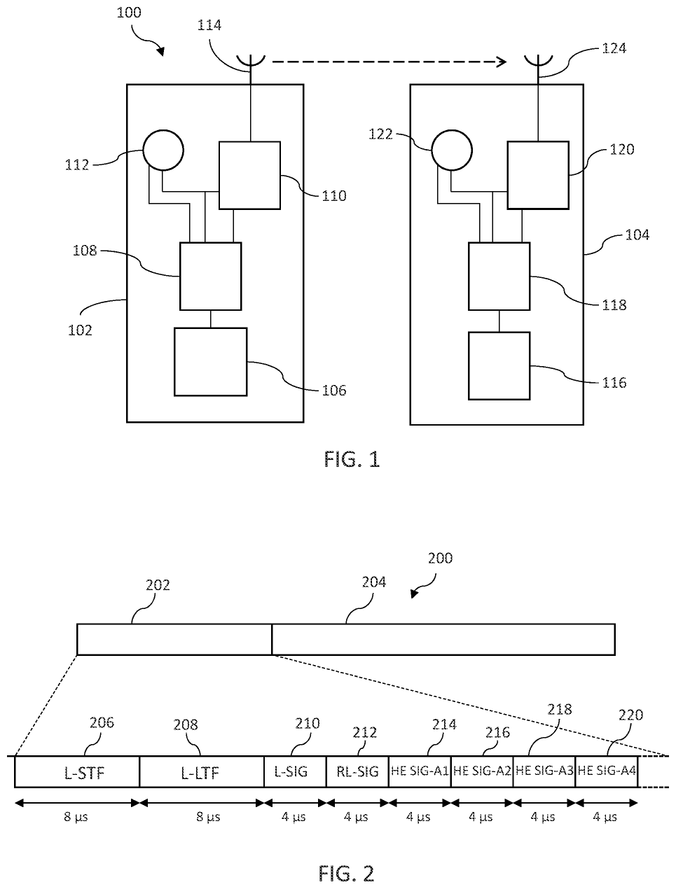

FIG. 1 shows a wireless communication system 100 that utilises the IEEE 802.11ax communication protocol. The wireless communication system 100 comprises an access point (AP) 102 and a client device station 104.

The access point 102 comprises a MAC interface 106, a baseband processor 108, an RF frontend portion 110, a local oscillator 112 and an antenna 114. In use, the MAC interface 106 connects the baseband processor 108 and RF frontend portion 110 to other components of the access point 102, such as a MAC processor (not shown). The baseband processor 108 handles (amongst other processes) physical layer (PHY) processes such as encoding, decoding, synchronisation and carrier frequency offset estimation. The RF frontend portion 110 handles processes such as modulation, multiplexing, demultiplexing and sampling and may comprise one or more DACs, ADCs, mixers, filters, amplifiers and/or baluns.

The client device station 104 similarly comprises a MAC interface 116, a baseband processor 118, an RF frontend portion 120, a local oscillator 122 and an antenna 124, which perform corresponding roles to those in the AP 102.

The operation of the wireless communication system 100 to transmit data from the access point 102 to the client device station 104 will now be described. Of course, the system 100 is also operable to transmit data from the client device station 104 to the access point 102.

In use, the access point 102 transmits packets of data to the client device station 104 using an IEEE 802.11ax packet structure. The wireless communication system 100 is arranged to use High Efficiency Extended Range Single User (HEERSU) format packets, along with other IEEE 802.11ax packets. The packets are sent using an OFDM protocol with data spread over 52 subcarriers. The structure of a HEERSU packet used by the wireless communication system 100 is illustrated in FIG. 2. The packet 200 comprises a preamble 202 and a payload 204. The preamble 202 includes legacy 802.11 fields including a legacy short training field (L-STF) 206, a legacy long training field (L-LTF) 208 and a legacy signal field (L-SIG) 210. The preamble 202 also includes additional (non-legacy) fields including a repeated legacy signal field (RL-SIG) 212. The RL-SIG 212 comes directly after the L-SIG 210 and is a repetition of the L-SIG 210.

The L-STF 206 is 8 μs long, and consists of ten repetitions of a fixed 0.8 μs pattern. The L-LTF 208 is also 8 μs long, and consists of two repetitions of a fixed 3.2 μs pattern, preceded by a 0.8 μs cyclic prefix (CP). The L-SIG 210 and the RL-SIG 212 both consist of the same 3.2 μs pattern with a 0.8 μs guard interval. Each consists of one OFDM symbol modulated simultaneously across the 52 subcarriers.

In the HEERSU packet 200, the RL-SIG 212 is followed by four HE SIG-A fields, each 4 μs long: HE SIG-A1 214, HE SIG-A2 216, HE SIG-A3 218 and HE SIG-A4 220. Each of the HE SIG-A fields 214, 216, 218, 220 is 4 μs long and consists of one OFDM symbol representing a 52-bit bitstream that is binary-phase-shift-key (BPSK) modulated simultaneously across the 52 subcarriers. Between them, the HE SIG-A fields 214, 216, 218, 220 carry 52 bits of packet-specific information, e.g. relating to modulation (e.g. modulation coding scheme), timing, bandwidth and/or coding of the packet. These 52 bits are R=½ rate encoded to get 104 coded bits. These 104 coded bits are divided into two halves. These two halves of encoded 52-bits are sent in the HE SIG-A fields 214, 216, 218, 220 as follows:

1 1) the first half of 52 encoded bits are subcarrier-interleaved and BPSK modulated to form the HE SIG-A1 field 214;
2) the first half of 52 encoded bits are QBPSK modulated to form the HE SIG-A2 field 216;
3) the second half of 52 encoded bits are subcarrier-interleaved and BPSK modulated to form the HE SIG-A3 field 218; and
4) the second half of 52 encoded bits are BPSK modulated to form the HE SIG-A4 field 220.

Thus, the HE SIG-A1 214 and HE SIG-A2 216 fields carry the same bits but differ in the order of subcarriers and modulation. Similarly, the HE SIG-A3 218 and HE SIG-A4 220 fields carry the same bits but differ in the order of subcarriers. Spreading the original 52 bits of information over four OFDM symbols with different subcarrier orders and modulations may improve redundancy and noise tolerance (i.e. facilitating extended range operation).

To successfully decode packets sent from the access point 102, the client device station 104 must be accurately synchronised with the timing and frequency of the incoming packet 200. For instance, the client device station 104 must know accurately the carrier frequency used by the incoming packet 200 and must be able to identify when an incoming packet 200 starts. The client device station 104 is configured to perform carrier frequency offset (CFO) estimation for the incoming packet 200, i.e. to estimate how different the carrier frequency for the incoming packet 200 is from the frequency of an internally-generated signal generated using the local oscillator 122 that is used to demodulate/decode the incoming packet. The incoming carrier frequency may differ from this internal frequency due to temperature and/or process variations in the local oscillators 112, 122, as well as channel effects (e.g. Doppler effects if the access point 102 and/or the client device station 104 are moving). In this example the actual CFO is 200 kHz.

The baseband processor 118 receives samples of an incoming data packet 200 from the RF frontend portion 120. The baseband processor 118 detects the start of the packet 200 by detecting the repeating pattern in the L-STF 206. The L-STF 206 pattern may also be used for automatic gain control (AGC), timing synchronisation, and determining an initial estimate of the CFO. This initial CFO estimate is used to correct for an estimated frequency offset, e.g. by adjusting the local oscillator 122 and/or by the baseband processor 118 compensating for the CFO digitally. In this example the estimated CFO from the L-STF 206 is 125 kHz thus leaving a residual frequency offset of 75 kHz.

The baseband processor 118 then uses the L-LTF 208 pattern to perform additional channel estimation, and to make another estimate of the CFO. The baseband processor 118 calculates a cross-correlation between the two repetitions of the fixed 3.2 μs pattern in the L-LTF 208 and uses this to estimate the CFO. In this example the estimated CFO from the L-LTF 208 is 35 kHz. This CFO estimate may be more accurate than the estimate made using the L-STF 206, because the L-LTF 208 repeating pattern is longer. The baseband processor 118 makes additional adjustments to the local oscillator 122 to compensate for the estimated CFO. Thus, the total CFO estimate at this stage is 160 kHz (125 kHz from the L-STF 206 plus 35 kHz from the L-LTF 208. This leaves 40 kHz of residual CFO.

The CFO estimates that use the L-STF 206 and L-LTF 208 are calculated using fixed repeating patterns, that do not change from packet to packet. Therefore, these estimates may be vulnerable to systematic errors or artefacts, i.e. they are not statistically robust.

Therefore, the baseband processor 118 then uses the L-SIG 210 and RL-SIG 212, and the HE SIG-A fields 214, 216, 218, 220 to perform further CFO estimation. These fields include packet-specific information (e.g. the L-SIG 210 and RL-SIG 212 identify the data rate and length of the packet 200). This information may vary from packet to packet, introducing variation and improving the statistical robustness of the CFO estimate.

The baseband processor 118 calculates a cross-correlation metric between a 3.2 μs of the L-SIG 210 and a corresponding 3.2 μis part of the RL-SIG 212, and uses this cross-correlation metric to estimate the CFO. Because the RL-SIG 212 is a repetition of the L-SIG 210, calculates a cross-correlation metric between the two fields provides an indication of CFO. The residual CFO estimated from the L-SIG 210 and RL-SIG 212 may be 38 kHz. Because the parts of the L-SIG 210 and the RL-SIG 212 have the same length as the repeating pattern in the L-LTF 208, the baseband processor 118 can re-use some of the same hardware and/or firmware and/or software for this cross-correlation.

Then, the baseband processor 118 calculates additional correlation metrics using pairs of the HE SIG-A fields 214, 216, 218, 220 and uses these to produce further estimates of CFO.

The baseband processor 118 then makes further adjustments (e.g. to the local oscillator 122 or in the baseband processor 118) to compensate for the residual CFO estimated using the L-SIG 210, RL-SIG 212 and HE SIG-A fields 214, 216, 218, 220, leaving, in this example, only 2 kHz of actual CFO.

The baseband processor 118 then proceeds to decode the rest of the packet.

The wireless communication system 100 is also arranged to use other types of IEEE 802.11ax packet. FIG. 8 shows another IEEE 802.11ax packet 800 comprising a preamble 802 and a payload 804. For instance, the packet 800 may comprise an IEEE 802.11ax High Efficiency Single User (HESU) format packet, an IEEE 802.11ax High Efficiency Multiple User (HEMU) format packet or an IEEE 802.11ax High Efficiency Trigger-Based (HETB) format packet.

The preamble 802 includes legacy 802.11 fields including a legacy short training field (L-STF) 806, a legacy long training field (L-LTF) 808 and a legacy signal field (L-SIG) 810. The preamble 802 also includes additional (non-legacy) fields including a repeated legacy signal field (RL-SIG) 812. The RL-SIG 812 comes directly after the L-SIG 810 and is a repetition of the L-SIG 810.

The L-STF 806 is 8 μs long, and consists of ten repetitions of a fixed 0.8 μs pattern. The L-LTF 808 is also 8 μs long, and consists of two repetitions of a fixed 3.2 μs pattern, preceded by a 0.8 μs cyclic prefix (CP). The L-SIG 210 and the RL-SIG 212 both consist of the same 3.2 μs pattern with a 0.8 μs guard interval. Each consists of one OFDM symbol modulated simultaneously across the 52 subcarriers.

Unlike the HEERSU packet 200, the IEEE 802.11ax packet 800 shown in FIG. 8 does not include the four HE SIG-A fields 214, 216, 218, 220 described above. When receiving such non-HEERSU packets, the client device station 104 still uses the legacy short training field (L-STF) 806, the legacy long training field (L-LTF) 808, the legacy signal field (L-SIG) 810 and the repeated legacy signal field (RL-SIG) 812 for CFO estimation as described herein.

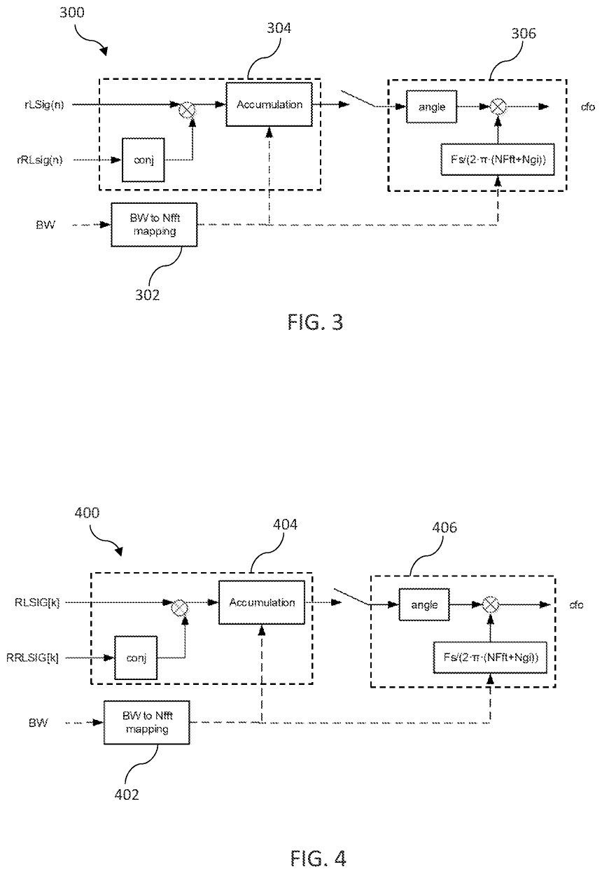

Two approaches to determining an estimate of CFO from the L-SIG 210 and the RL-SIG 212 will now be described with reference to FIGS. 3 and 4. The steps illustrated in FIG. 3 and FIG. 4 may be carried out by the baseband processor 118.

Let sLsig(n) represent transmitted L-SIG time-domain samples and SLSIG(k) represent L-SIG frequency-domain symbols. rLsig(n) represents received L-SIG time-domain samples, with frequency-domain symbols represented by RLSIG(k). rRlsig(n) represents received RL-SIG time-domain samples, with frequency-domain symbols represented by RRLSIG(k). Time indices are represented as 0≤n≤(NFft−1). Sub-carrier indices are represented as 0≤k≤(NFft−1), where NFft is the fast-Fourier-transform (FFT) size (which is typically fixed based on the bandwidth of the radio signal).

Ideally, in the absence of any channel effects and RF/AFE impairments, rLsig(n)=sLsig(n) and rRlsig(n)=sLsig(n). If only the effect of CFO is considered, with CFO represented as ΔF (in Hz) and normalised CFO as

$$Δ f = \frac{Δ F}{Fs}$$

(where Fs is the sampling rate in Hz):

rLsig(n)=sLsig(n)·e^{j2π·Δf·n},

rRlsig(n)=sLsig(n)·e^{j2π·Δf·(n+NFft+NGi}),

NGi is the guard interval size. Omitting any Inter Carrier Interference (ICI), the frequency domain symbols may be given as:

RLSIG(k)=SLSIG(k−ΔF/Fs).

FIG. 3 shows schematically a time-domain (TD) approach 300 to estimating CFO using time-domain samples of the L-SIG 210 and the RL-SIG 212. In a first step 302, the bandwidth BW is mapped to a fast Fourier transform size NFft.

The L-SIG 210 and RL-SIG 212 are, typically, very highly correlated. In a second step 304, the TD cross correlation of these fields is calculated by accumulating over the time indices n the product of rLsig(n) and the conjugate of rRlsig(n):

$$\begin{matrix}{p}_{RLSIG , RRLSIG} & = {\sum }_{n = 0}^{NFft - 1} rLsig ( n ) . {( rRlsig ( n ) )}^{*} \\ & = {\sum }_{n = 0}^{NFft - 1} sLsig ( n ) . {e}^{j 2 π . Δ f . n} . {( sLsig ( n ) . {e}^{j 2 π . Δ f . ( n + NFft + NGi )} )}^{*}\end{matrix}$$

On simplification:

$$\begin{matrix}{p}_{RLSIG , RRLSIG} = ( {\sum }_{n = 0}^{NFft - 1} {\vert sLsig ( n ) \vert}^{2} ) .\end{matrix} {e}^{- j 2 π . ( \frac{Δ F}{Fs} ) . ( NFft + NGi )}$$

It can be observed that the angle of above term is indicative of frequency offset. Thus the normalised CFO can be estimated as:

$$= - \frac{angle ( {p}_{RLSIG , RRLSIG} )}{2 π . ( NFft + NGi )} = - \frac{angle ( {\sum }_{k = 0}^{NFft - 1} rLsig ( n ) . {( rRlsig ( n ) )}^{*} )}{2 π . ( NFft + NGi )}$$

Therefore, in a third step 306, the CFO (in Hz) is calculated as the product of the angle above and the sampling rate Fs:

$$\begin{matrix}= . Fs & = - \frac{angle ( {p}_{RLSIG , RRLSIG} )}{2 π . ( NFft + NGi )} . Fs \\ & = - \frac{angle ( {\sum }_{k = 0}^{NFft - 1} rLsig ( n ) . {( rRlsig ( n ) )}^{*} )}{2 π . ( NFft + NGi )} . Fs\end{matrix}$$

FIG. 4 shows schematically a frequency-domain (FD) approach 400 to estimating CFO using frequency domain sub-carriers of the L-SIG 210 and the RL-SIG 212. In a first step 402, the bandwidth BW is mapped to a fast Fourier transform size NFft.

In a second step 404, a FD cross correlation is calculated by accumulating over the sub-carrier indices k the product of the RLSIG(k) (frequency-domain L-SIG 210 symbols) and the conjugate of RRLSIG(k) (frequency-domain RL-SIG 212 symbols):

$$\begin{matrix}{p}_{RLSIG , RRLSIG} & = {\sum }_{k = 0}^{NFft - 1} RLSIG ( k ) . {( RRLSIG ( k ) )}^{*} \\ & = {\sum }_{k = 0}^{NFft - 1} SLSIG ( k - Δ F / Fs ) . {( SLSIG ( k - Δ F / Fs ) . {e}^{- j 2 π . ( \frac{Δ F}{Fs} ) . ( NFft + NGi )} )}^{*}\end{matrix}$$

On simplification:

$$\begin{matrix}{p}_{RLSIG , RRLSIG} = ( {\sum }_{k = 0}^{NFft - 1} {\vert SLSIG ( k - Δ F / Fs ) \vert}^{2} ) .\end{matrix} {e}^{- j 2 π . ( \frac{Δ F}{Fs} ) . ( NFft + NGi )}$$

It can be observed that the angle of above term is indicative of frequency offset. Thus the normalised CFO can be estimated as

$$= - \frac{angle ( {p}_{RLSIG , RRLSIG} )}{2 π . ( NFft + NGi )} = - \frac{angle ( {\sum }_{k = 0}^{NFft - 1} RLSIG ( k ) . {( RRLSIG ( k ) )}^{*} )}{2 π . ( NFft + NGi )}$$

In a third step 406, the CFO (in Hz) can be estimated as the product of the angle above and the sampling rate Fs:

$$= \cdot Fs = - \frac{angle ( {P}_{RLSIG , RRLSIG} )}{2 π \cdot ( NFft + NGi )} \cdot Fs = - \frac{angle ( {Σ}_{k = 0}^{NFft - 1} RLSIG ( k ) \cdot {( RRLSIG ( k ) )}^{*} )}{2 π \cdot ( NFft + NGi )} \cdot Fs$$

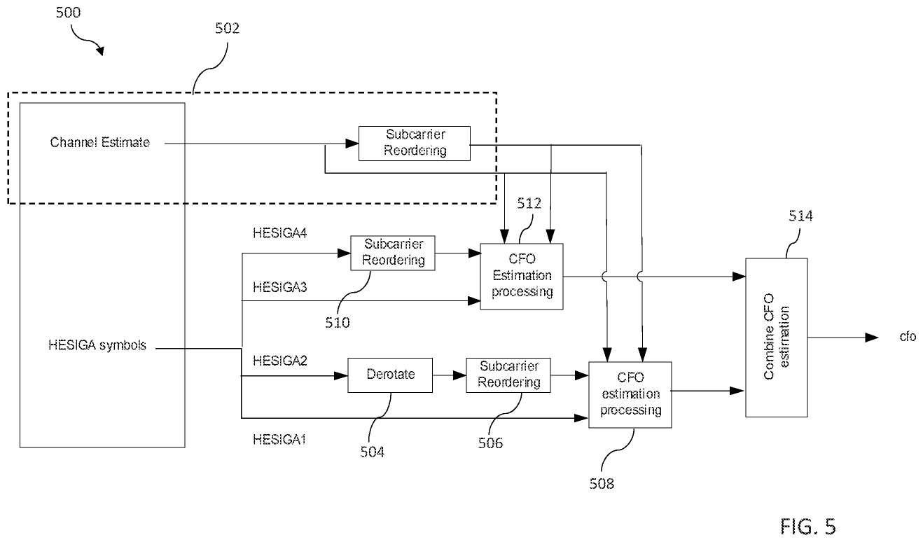

An approach to using the HE SIG-A fields 214, 216, 218, 220 to perform further CFO estimation will now be described with additional reference to FIG. 5.

As explained above, the HE SIG-A1 214 and HE SIG-A2 216 fields carry the same bits but with different subcarrier orders and with different modulation. Therefore, useful CFO information can be obtained by performing a correlation operation between the HE SIG-A1 214 and HE SIG-A2 216 fields after appropriate derotation and subcarrier re-ordering. Similarly, the HE SIG-A3 218 and HE SIG-A4 220 fields vary the same bits with different subcarrier orders.

Let X(k, n) represent the k′th subcarrier of the HE SIG-A fields 214, 216, 218, 220 where n=1,2,3 and 4 correspond to HE SIG-A1 214, HE SIG-A2 216, HE SIG-A3 218 and HE SIG-A4 220 fields respectively. Let i(k) represent interleaving pattern index of k′th subcarrier index. The sub-carrier indices are represented as 0≤k≤(NFft−1), where NFft is the FFT size (which is always fixed for primary signal BW). Let Ng represent the number of Cyclic Prefix (CP) sample.

Let S(k,1) be the OFDM symbols from first half of 52-bits after encoded bit to constellation symbol mapping and constellation symbol to OFDM subcarrier index (k) mapping.

Let S(k,2) be the OFDM symbols from second half of 52-bits after encoded bit to constellation symbol mapping and constellation symbol to OFDM subcarrier index (k) mapping.

Skipping details of the encoded bit to constellation symbol mapping and constellation symbol to OFDM subcarrier mapping of the First half of 52 bits, let HE SIG-A2 216 OFDM symbols be represented as:

X(k, 2)=j·S(k,1)

The OFDM symbol of HE SIG-A1 214 can be represented as:

X(i(k), 1)=S(k,1)

Skipping details of the encoded bit to constellation symbol mapping and constellation symbol to OFDM subcarrier mapping of the second half of 52 bits, let HE SIG-A4 220 OFDM symbols be represented as:

X(k, 4)=S(k,2)

The OFDM symbol of HE SIG-A3 218 can be represented as:

X(i(k), 3)=S(k,2)

Let H(k) be the effective channel between the AP 102 and the client device station 104 for subcarrier k. The received symbols can be represented as:

R(k, n)=H(k)·X(k,n)

If CFO is represented as ΔF (in Hz) and normalised CFO as Δf=ΔF/Fs, where Fs is the sampling rate (in Hz). Let the first TD samples of HE SIG-A1 214 be taken as phase reference. Then the first samples of HE SIG-A2 216, HE SIG-A3 218 and HE SIG-A4 220 have initial phase offsets of 2π(ΔF/Fs)(Ng+Nfft)×1, 2π(ΔF/Fs)(Ng+Nfft)×2 and 2π(ΔF/Fs)(Ng+Nfft)×3 respectively.

CFO also give rise to a frequency domain shift and ICI in each OFDM symbol of HE SIG-A.

In the presence of channel and CFO, ignoring ICI, the received HE SIG-A fields 214, 216, 218, 220 can be represented as

$$R ( k , n ) = H ( k - \frac{Δ F}{F s} ) \cdot X ( k - \frac{Δ F}{F s} , n ) \cdot {e}^{j 2 π \cdot ( \frac{Δ F}{F s} ) \cdot ( NFft + NGi ) ( n - 1 )}$$

Approximating the channel estimate as H(k−(ΔF/Fs))=H(k)

The received OFDM symbol can be represented as:

$$R ( k , n ) = H ( k ) \cdot X ( k - \frac{Δ F}{F s} , n ) \cdot {e}^{j 2 π \cdot ( \frac{Δ F}{F s} ) \cdot ( NFft + NGi ) ( n - 1 )}$$

In a first step 502, the baseband processor 118 performs channel estimation to calculate H(k) for each subcarrier k. The channel estimates for each subcarrier are re-ordered to match the subcarrier order of the HE SIG-A1 and HE SIG-A3 fields 214, 218.

Req(k, n) is the channel equalised received OFDM symbol:

$$R e q ( k , n ) = \frac{R ( k , n )}{H ( k )} = X ( k - \frac{Δ F}{F s} , n ) \cdot {e}^{j 2 π \cdot ( \frac{Δ F}{F s} ) \cdot ( NFft + NGi ) ( n - 1 )}$$

In step 504, the HE SIG-A2 field 216 (which is QPBSK modulated) is derotated. In a next step 506, the subcarriers of the HE SIG-A2 216 field are re-ordered (i.e. de-interleaved) to correspond with those of the HE SIG-A1 field 214.

In step 508, the HE SIG-A1 field 214 and the de-rotated, re-ordered HE SIG-A2 field 216 are combined with the channel estimates determined in step 502 to determine an estimate of CFO in the following manner.

### HE SIG-A1-HE SIG-A2 Processing Algorithm

As explained above, the received HE SIG-A1 symbol 214 is maintained as such and the received HE SIG-A2 216 is processed (de-rotated and re-ordered) to match the modulation and subcarrier ordering of HE SIG-A1 214.

The channel-equalised received HE SIG-A2 symbols 216 at sub-carrier index ‘k’ can be represented as:

$$Req ( k , 2 ) = X ( k - \frac{Δ F}{Fs} , 2 ) \cdot {e}^{j 2 π \cdot ( \frac{Δ F}{F s} ) \cdot ( NFft + NG ) ( 2 - 1 )} = j \cdot S ( k - \frac{Δ F}{Fs} , 1 ) \cdot {e}^{j 2 π \cdot ( \frac{Δ F}{F s} ) \cdot ( NFft + NG )}$$

The derotated symbol can be represented as:

$$Rderot ( k , 2 ) = \frac{R e q ( k , 2 )}{j} = S ( k - \frac{Δ F}{F s} , 1 ) \cdot {e}^{j 2 π \cdot ( \frac{Δ F}{F s} ) \cdot ( NFft + NG )}$$

The channel-equalised received HE SIG-A1 symbols 214 corresponding to subcarrier index ‘k’ at interleaved subcarrier index i(k) can be given as:

$$R e q ( i ( k ) , 1 ) = X ( i ( k ) - \frac{Δ F}{F s} , 2 ) \cdot {e}^{j 2 π \cdot ( \frac{Δ F}{F s} ) \cdot ( NFft + NGi ) ( 1 - 1 )} = S ( k - \frac{Δ F}{F s} , 1 )$$

The correlation of Rderot(k, 2) and Req(i(k), 1) can be expressed as follows:

$${P}_{HESIGA 2 , HESIGA 1} = {\sum }_{k = 0}^{NFft - 1} R d e r o t ( k , 2 ) \cdot ( Req ( i ( k ) , 1 ) ) = {\sum }_{k = 0}^{NFft - 1} ( S ( k - \frac{Δ F}{F s} , 1 ) \cdot {e}^{j 2 π \cdot ( \frac{Δ F}{F s} ) \cdot ( NFft + NG )} ) \cdot {( S ( k - \frac{Δ F}{F s} , 1 ) )}^{*}$$

On simplification:

$${P}_{HESIGA 2 , HESIGA 1} = ( {\sum }_{k = 0}^{NFft - 1} {\vert S ( k - \frac{Δ F}{Fs} , 1 ) \vert}^{2} ) \cdot {e}^{j 2 π \cdot ( \frac{Δ F}{F s} ) \cdot ( NFft + NG )}$$

It can be observed that angle of above term is indicative of frequency offset. Thus, the normalised CFO can be estimated as:

$${HESIGA 2 , HESIGA 1}_{} = {HESIGA 2 , HESIGA 1}_{} \cdot Fs = \frac{angle ( {P}_{HESIGA 2 , HESIGA 1} )}{2 π \cdot ( NFft + NG )} \cdot Fs = \frac{{angle ( {\sum }_{k = 0}^{NFft - 1} Rderot ( k , 2 ) \cdot ( Req ( i ) k ) , 1 ) )}^{*} )}{2 π \cdot ( NFft + NG )} \cdot Fs$$

The CFO (in Hz) can be estimated as:

$${HESIGA 2 , HESIGA 1}_{} = \frac{angle ( {P}_{HESIGA 2 , HESIGA 1} )}{2 π \cdot ( NFft + NG )} = \frac{{angle ( {\sum }_{k = 0}^{NFft - 1} Rderot ( k , 2 ) \cdot ( Req ( i ) k ) , 1 ) )}^{*} )}{2 π \cdot ( NFft + NG )}$$

A similar process is performed for the HE SIG-A3 218 and HE SIG-A4 220 fields. In step 510, the subcarriers of the HE SIG-A4 220 field are re-ordered (i.e. de-interleaved) to correspond with those of the HE SIG-A3 field 218.

In step 512, the HE SIG-A3 field 218 and the re-ordered HE SIG-A4 field 220 are combined with the channel estimates determined in step 502 to determine another estimate of CFO, in an analogous manner to that described above for the HE SIG-A1 and HE SIG-A2 fields 214, 216.

Finally, in step 514, the CFO estimates from steps 508 and 512 are combined, e.g. by averaging.

Alternatively to steps 508, 512 and 514, raw correlation results between HE SIG-A1 214 and HE SIG-A2 216, and HE SIG-A3 218 and HE SIG-A4 220 may be combined and a CFO estimate determined from the combined correlation metric.

First, the correlation value P_{HESIGA2,HESIGA1} computed in the HE SIG-A1/HE SIG-A2 processing is combined with a corresponding value P_{HESIGA4,HESIGA3} for HE SIG-A3/HE SIG-A4 processing (computed in a corresponding manner to that described above for the HE SIG-A1/HE SIG-A2 fields):

P_{HESIGA}=P_{HESIGA2,HESIGA1}+P_{HESIGA4,HESIGA3}

On substitution of previous results:

$${P}_{HESIGA} = ( {\sum }_{k = 0}^{NFft - 1} {\vert S ( k - \frac{Δ F}{Fs} , 1 ) \vert}^{2} ) \cdot {e}^{j 2 π \cdot ( \frac{Δ F}{F s} ) \cdot ( NFft + NG )} + ( {\sum }_{k = 0}^{NFft - 1} {\vert S ( k - \frac{Δ F}{Fs} , 2 ) \vert}^{2} ) \cdot {e}^{j 2 π \cdot ( \frac{Δ F}{F s} ) \cdot ( NFft + NG )}$$

On simplification:

$${P}_{HESIGA} = ( {\sum }_{k = 0}^{NFft - 1} {\vert S ( k - \frac{Δ F}{Fs} , 1 ) \vert}^{2} + {\vert S ( k - \frac{Δ F}{Fs} , 2 ) \vert}^{2} ) \cdot {e}^{j 2 π \cdot ( \frac{Δ F}{F s} ) \cdot ( NFft + NG )}$$

It can be observed that angle of above term is indicative of frequency offset. Thus, the normalised CFO can be estimated as:

$${HESIGA}_{} = \frac{angle ( {P}_{HESIGA} )}{2 π \cdot ( NFft + NG )}$$

The CFO (in Hz) can be estimated as:

$${HESIGA}_{} = {HESIGA}_{} \cdot Fs = \frac{angle ( {P}_{HESIGA} )}{2 π \cdot ( NFft + NG )} \cdot Fs$$

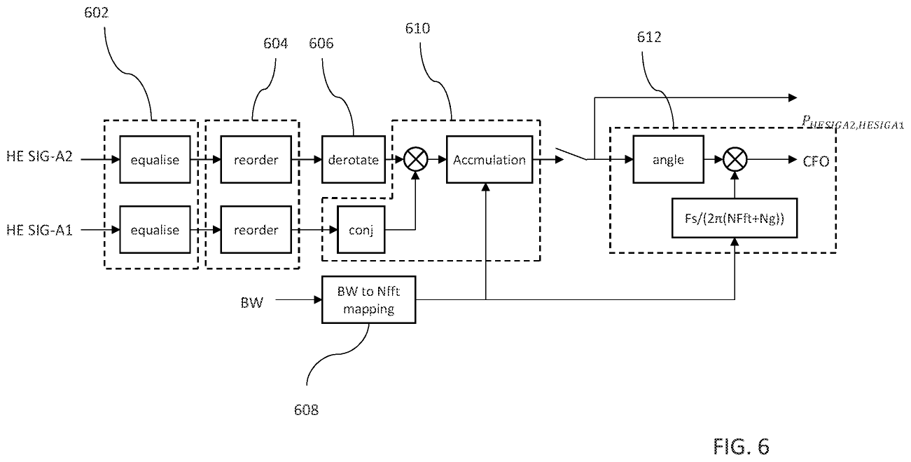

FIG. 6 illustrates processing of the HE SIG-A1 and HE SIG-A2 fields 214, 216 in more detail. In step 602 the channel estimates for each subcarrier calculated by the baseband processor 118 are used for channel equalisation for the HE SIG-A1 and HE SIG-A2 fields 214, 216. In step 604, the subcarriers of the HE SIG-A1 and HE SIG-A2 fields 214, 216 are reordered to correspond (this may involve reordering of one or both of the HE SIG-A1 and HE SIG-A2 fields 214, 216. In step 606, the HE SIG-A2 field 216 (which is QPBSK modulated) is derotated. As explained above, channel equalisation may also be performed after reordering and derotation.

The subsequent steps correspond to steps 402, 404 and 406 explained above in more detail with reference to FIG. 4. Hardware and/or software for performing these steps for the L-SIG 210 and the RL-SIG 212 may be re-used to estimate CFO from the HE SIGA fields 214, 216, 218, 220.

In step 608, the bandwidth BW is mapped to a fast Fourier transform size NFft.

In step 610, a FD cross correlation is calculated by accumulating over the sub-carrier indices k the product of the HESIGA1(k) (frequency-domain HE SIG-A1 214 symbols) and the conjugate of HESIGA2(k) (frequency-domain HE SIG-A2 216 symbols). The resulting correlation value is P_{HESIGA2,HESIGA1}. The angle of the correlation result is indicative of frequency offset.

In step 612, the CFO (in Hz) can be estimated as the product of the angle above and the sampling rate Fs.

A corresponding process (without the derotating step 606) is performed to estimate the CFO using the HE SIG-A3 and HE SIG-A4 fields 218, 220.

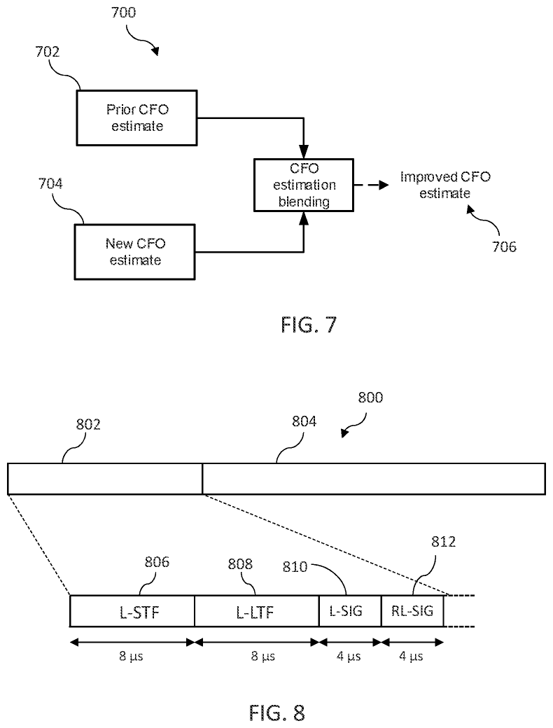

FIG. 7 shows schematically an approach 700 to estimating a frequency offset between a radio signal and a radio receiver device using a previously-estimated carrier frequency offset (e.g. calculated from legacy fields and/or from previous packets).

A previous CFO estimate 702 (e.g. from a previously received packet, or produced from the L-STF 206 or L-LTF 208 of the same packet) is cfoₚᵣᵢₒᵣ. A new CFO estimate 704 (e.g. using the L-SIG and RL-SIG as described above) is cfo_{new}.

An improved CFO estimate 706 cfo_{improved} may then be calculated using a weighted sum of cfoₚᵣᵢₒᵣ and cfo_{new}. This is shown in the equation below, where wₚᵣᵢₒᵣ and w_{new} are the weights applied. These weights may be chosen when designing the system.

cfo_{improved}=cfoₚᵣᵢₒᵣ·wₚᵣᵢₒᵣcfo_{new}·w_{new}

In one example, the weights may be equal (e.g. wₚᵣᵢₒᵣ=w_{new}=1) Alternatively, the weights may be different. For instance, a new CFO estimate 704 determined using the L-SIG 210 and RL-SIG 212 may be weighted more strongly than a prior CFO estimate 702 determined using the L-LTF 208 earlier in the same packet, because the L-SIG/RL-SIG estimate is more statistically robust.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio receiver device configured:
to receive a radio signal comprising a data packet, said data packet comprising a first portion comprising an encoded bit sequence and including information specific to the data packet and a second portion comprising an encoded bit sequence and comprising corresponding information specific to the data packet;
to calculate a correlation metric using the first portion and the second portion; and
to estimate a carrier frequency offset between the radio signal and the radio receiver device using the correlation metric.

2. The radio receiver device of claim 1, wherein the first portion includes information identifying a data rate and/or a length of one or more portions of the data packet.

3. The radio receiver device of claim 2, wherein the data packet is an IEEE 802.11ax High Efficiency Extended Range Single User format packet.

4. The radio receiver device of claim 3, wherein the first portion comprises a legacy signal (L-SIG) field and the second portion comprises a repeated legacy signal field (RL-SIG).

5. The radio receiver device of claim 3, wherein the first portion comprises a first part of a High Efficiency Signal A field and the second portion comprises a second part of a High Efficiency Signal A field.

6. The radio receiver device of claim 1, wherein calculating the correlation metric between the first portion and the second portion comprises performing a correlation operation such as a cross correlation.

7. The radio receiver device of claim 6, wherein the second portion is not a repetition of the first portion and wherein calculating the correlation metric comprises performing one or more initial processing steps to one or both of the first and second portions prior to performing the correlation operation.

8. The radio receiver device of claim 7, wherein the first and second portions comprise information spread differently over a plurality of frequency bands, and calculating the correlation metric comprises reordering frequency bands of the first and/or second portions.

9. The radio receiver device of claim 7, wherein the second portion uses a different modulation scheme to the first portion, and calculating the correlation metric comprises converting the modulation of the first and/or second portion.

10. The radio receiver device of claim 1, wherein the data packet comprises a third portion including information specific to the data packet and a fourth portion comprising corresponding information to the third portion, and the radio receiver device is be arranged to use the first and fourth portions to improve the estimate of carrier frequency offset between the radio signal and the radio receiver device.

11. The radio receiver device of claim 10, arranged to determine a first intermediate CFO estimate using said first and second portions, to determine a second intermediate CFO estimate using third and fourth portions, and to estimate the carrier frequency offset between the radio signal and the radio receiver device by calculating an average of the first and second intermediate CFO estimates.

12. The radio receiver device of claim 10, arranged to calculate a first correlation metric using the first portion and the second portion, to calculate a second correlation metric using the third portion and a fourth portion, to calculate a combined correlation metric from said first and second correlation metrics and to estimate the carrier frequency offset between the radio signal and the radio receiver device using the combined correlation metric.

13. The radio receiver device of claim 1, wherein the preamble of the data packet comprises a synchronisation portion which includes a fixed, repeated pattern, and the radio receiver device is configured to determine an initial estimate for the carrier frequency offset between the radio signal and the radio receiver device using the synchronisation portion of the preamble.

14. The radio receiver device of claim 13, configured to calculate an additional correlation metric for a repeated fixed pattern in a synchronisation portion and to determine the initial estimate for the carrier frequency offset using said additional correlation metric.

15. The radio receiver device of claim 13, configured to calculate the correlation metric between the first and second portion using parts of the first and second portion having a length equal to a fixed repeated pattern in a synchronisation portion.

16. The radio receiver device of claim 13, configured to compensate for the initial estimate of the carrier frequency offset estimated using the synchronisation portion and then to compensate for the carrier frequency offset estimated using the first and second portions.

17. The radio receiver device of claim 1, configured to calculate a weighted average of a previously-estimated or otherwise previously-known carrier frequency offset and the carrier frequency offset estimated using the correlation metric.

18. The radio receiver device of claim 1, arranged to use the correlation metric to derive a phase offset between the first and second portions.

19. A wireless communication system comprising:
a radio transmitter device arranged to transmit a radio signal comprising a data packet, said data packet comprising a first portion comprising an encoded bit sequence and including information specific to the data packet and a second portion comprising an encoded bit sequence and comprising corresponding information specific to the data packet; and
a radio receiver device as claimed in any preceding claim arranged to receive the radio signal.

20. A method of operating a radio receiver device, said method comprising:
receiving a radio signal comprising a data packet, said data packet comprising a first portion comprising an encoded bit sequence and including information specific to the data packet and a second portion comprising an encoded bit sequence and comprising corresponding information specific to the data packet;
calculating a correlation metric using the first portion and the second portion;
estimating a carrier frequency offset between the radio signal and the radio receiver device using the correlation metric.
